(19) United States
(12) Patent Application Publication
(10) Pub. No.: US 2006/0145429 A1
(43) Pub. Date: Jul. 6, 2006

(54) High dielectric fluid joint gasket

(76) Inventors: Arvid Casler, Mundelein, IL (US); John B. Cofrin, Bloomingdale, IL (US); Vijay Bommareddy, Hoffman Estates, IL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/237,141

(22) Filed: Sep. 28, 2005

Related U.S. Application Data
(60) Provisional application No. 60/614,250, filed on Sep. 29, 2004.

(51) Int. Cl. F16J 15/08

(52) U.S. Cl. 277/627

(57) ABSTRACT

A gasket assembly has at least one fluid-conveying opening and at least one bolt hole. The gasket includes PEEK material that may be applied as a layer to at least a portion of a metal core of the gasket. A layer of elastomeric sealing material is applied to at least a portion of the PEEK material.

This invention claims priority to U.S. Provisional Patent Application No. 60/614,250, filed Sep. 29, 2004.

### BACKGROUND OF THE INVENTION

1. Technical Field

This invention relates generally to metal gaskets, and more particularly to those used in applications in which the gasket is clamped between adjacent components in the presence of an electrolytic fluid which, if not properly protected, could result in the gasket serving as a metallic conductive pathway leading to electrolytic corrosion of the adjacent component parts.

2. Related Art

Metal gaskets are used in numerous applications to provide a fluid-tight seal between adjacent components. One such application is a gasket for an oil cooler core. The gasket is of the type having a metal embossment surrounding the fluid opening to be sealed and including a plurality of bolt hole openings to accommodate the passage of bolts used to clamp the components to one another with the gasket therebetween. In some instances, it has been found that the adjacent components are susceptible to corrosion and it is believed that the metal gasket is serving at least in part as a conductive pathway between the components to establish an undesirable corrosion cell that, in the presence of the fluid, leads to undesirable electrogalvanic corrosion of the adjacent components. The corrosion cell is believed to consist of the mounting bolts, the gasket, the fluid (electrolytes) exposed to both the inside and outside of the bolted flange and gasket, and dissimilar bolted flange materials. The gaskets in current use are typically coated with an elastomer to enhance sealing at the interface between the gasket and adjacent components. While such a coating provides some level of insulating value in some areas, it has been found that around the bolt holes and near mold standoff locations on the gasket, at points where the material is injected around the metal gasket core, the elastomer material can abraided away in use, leaving the metal core in these areas exposed to the clamped components, setting up electrical conductive paths which lead to the electrogalvanic corrosion problems. Thus, while the elastomeric material is needed and desirable for enhancing the overall sealing capability of the gasket, it is insufficient to prevent electrogalvanic corrosion, particularly around the bolt hole regions where the material is abraided away during installation and use of the gasket.

### SUMMARY OF THE INVENTION AND ADVANTAGES

A gasket constructed according to the present invention has an exposed gasket surface of PEEK material in the regions prone to abrasion, such as around the bolt holes, and preferably covering the entire gasket core. According to a first embodiment, the gasket core is fabricated of steel or other metal material and then coated with the PEEK material. The PEEK material has the advantage of offering high dialectic insulating properties which serves as an electrical barrier to disrupt the metallic conductive pathway through the gasket that had heretofore been identified as at least contributing to the establishment of an electrogalvanic cell which caused corrosion of the adjoining components that are clamped. In a second embodiment, the entire core of the gasket is made of PEEK, such as being stamped from a sheet of the PEEK material. In both embodiments, and according to the invention, on top of the PEEK regions there is applied a layer of elastomer to promote sealing of the gasket. However, the elastomer is not applied to those areas prone to abrasion, such as near the bolt holes, where only the PEEK is exposed and can tolerate the conditions to maintain the desired insulating properties while providing a base for which the elastomer can adhere to. According to a further feature, the PEEK material can be masked or removed form the edges of the fluid opening to promote optional adhesion of the elastomer material to the metal core material.

Accordingly, the provision of the PEEK material to the core gasket, particularly in the high abrasion bolt hole regions, provides the desired high dielectric insulating properties to interrupt the metallic conductive pathway through the gasket that would otherwise exist, and the overlying elastomer provides the desired sealing properties to enhance the sealability of the gasket.

### THE DRAWINGS

These and other features and advantages of the present invention will become more readily appreciated when considered in connection with the following detailed description and appended drawings, wherein:

FIG. 1 is a plan view of a gasket according to a first embodiment of the invention;

FIG. 2 is a plan view of a metal gasket core;

FIG. 3 is a plan view like FIG. 2 following coating with PEEK material;

FIG. 4 is an enlarged plan view of the fluid opening showing a rim of exposed core metal;

FIG. 5 is a plan view of the bolt hole and standoff regions which are free of elastomer material;

FIG. 6 is a cross sectional view of the bolt holes and standoff regions;

FIG. 7 is a cross sectional view taken along lines 7-7 of FIG. 4 and with an elastomer layer applied;

FIG. 8 is a plan view of an alternative gasket;

FIG. 9 is a plan view of an alternative core made of PEEK material associated with the gasket of FIG. 8; and

FIG. 10 is a cross sectional view taken along lines 10-10 of FIG. 8.

### DETAILED DESCRIPTION OF THE PREFERRED EMBODIMENT

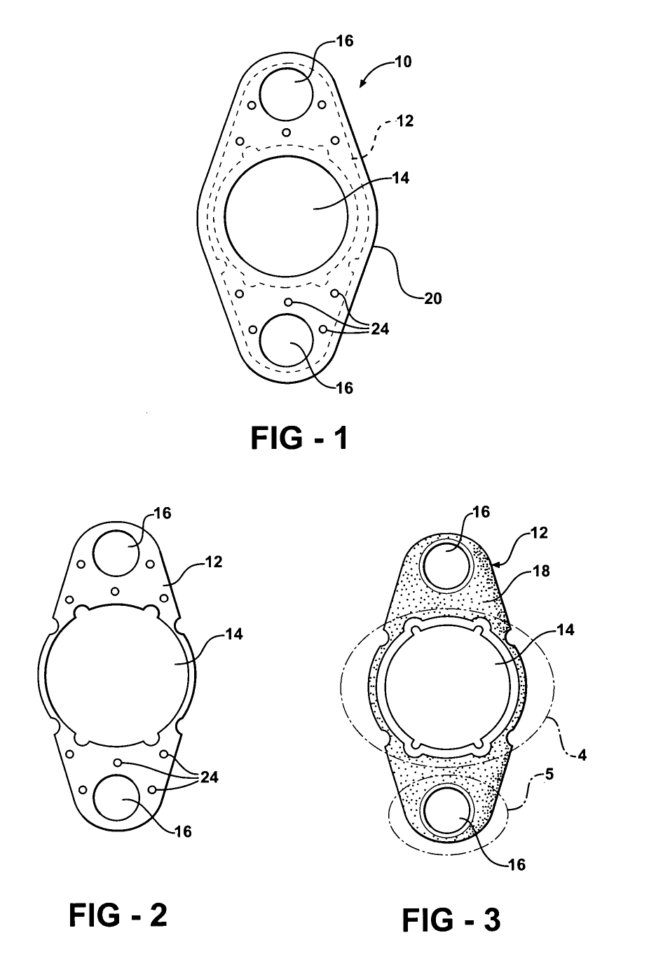

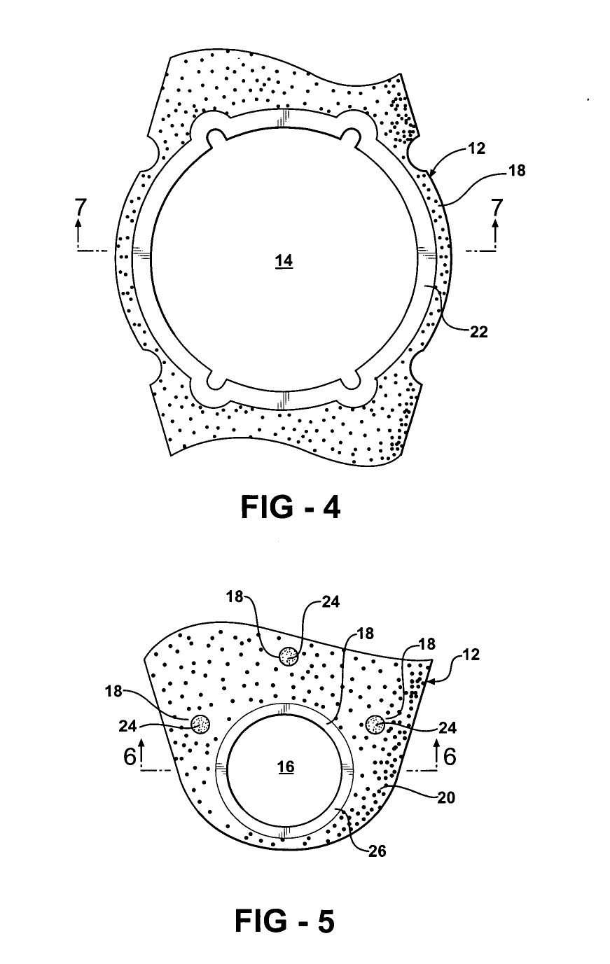

A metal gasket constructed according to a presently preferred embodiment of the invention is shown generally at 10 in FIGS. 3 and 4 and comprises a gasket core 12 (FIG. 1) which serves as the structural framework or backbone of the gasket. The core 12 is formed with at least one fluid opening 14 for conveying a fluid through the gasket 10. The gasket 10 may comprise, for example, an oil cooler gasket designed to be clamped between an oil cooler and an engine block (neither of which are shown) for forming a fluid-tight seal therebetween. The gasket 10 further includes at least one and preferably at least two bolt hole openings 16 formed through the core 10 in spaced relation to the fluid opening 14 and designed to accommodate the passage of mounting bolts (not shown) used for fastening the oil cooler to the block and, when tightened, to compress the gasket 10 to establish the fluid-tight seal between the oil cooler and block to prevent the leakage of fluid conveyed between the oil cooler and block from escaping at the gasket joint.

Both the fluid opening 14 and the bolt hole openings 16 are formed slightly oversized in relation to their final dimension, as illustrated in FIG. 2, wherein the dotted lines represent the final size of the openings 14, 16.

According to a first preferred embodiment of FIGS. 1-7, the gasket core 12 is fabricated of a plain carbon steel or other non-PEEK material, and preferably of stamped carbon steel. According to the invention, the core 12 is first coated with a dispersion coating of pure PEEK (polyethyletherkeytone), as illustrated in FIG. 3. The preferred thickness is about 2 μm. One material shown to be successful in connection with the present invention is available from Techline Coatings under the product name “Techtrix 7100”. The PEEK material bonds well to the steel carrier and has high dielectric properties which forms an electrical insulating barrier around the core 12, disrupting any conductive electrical path through the gasket 10, as will be explained in further detail below.

Once the core 12 has been coated with the layer of PEEK material 18, an outer coating of an elastomer layer 20 is applied. The elastomer layer 20 is preferably rubber based and is molded about the core 12 and PEEK layer 18 such that the core 12 and PEEK layer 18 are substantially encapsulated by the elastomer layer 20, except in certain areas described below. The preferred elastomer is a silicon-based injected molded elastomer, and may be those currently used in production in connection with existing oil cooler core gasket in which the elastomer material is bonded directly to the metal core without use of the intervening PEEK layer. Those skilled in the art will appreciate that this is but one elastomer material that could be used, and that the invention contemplates a variety of elastomers provided they are compatible with PEEK and with the intended gasket application. The silicone elastomer currently in use in production for existing oil cool core gaskets and employed as the elastomer layer 20 of the present invention is prepared according to Federal-Mogul material specification R7725.

Prior to application of the elastomer layer 20, it is preferred that the PEEK material 18 be trimmed away from the fluid opening 14 to expose an uncoated annular rim 22 of the core 12 immediately surrounding the fluid opening 14 that is free of the PEEK material 18, as illustrated in FIG. 4. In practice, the uncoated rim 22 can be prepared by first coating and then removing the PEEK material 18, or by masking the rim region 22 during application of the PEEK materialm so as to shield them from application of the PEEK material 18. In either case, the PEEK material 18 is set back about 0.070 inches around the fluid opening 14 and away from the raised tool standoff features 24 to reveal bare steel of the core 12 for direct bonding of the elastomer material 20 to these regions only, with all other regions of the gasket 10 being covered with PEEK and encapsulated by the elastomer layer 20.

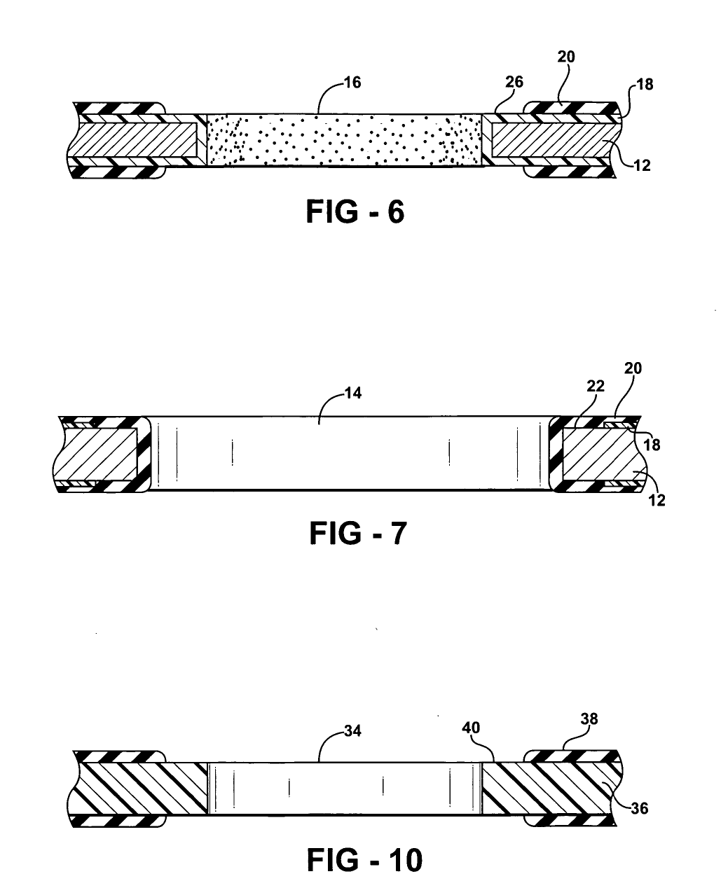

Once the core 12 is coated with the PEEK layer 18 and either trimmed or masked against the presence of the PEEK material around the fluid openings 14, the PEEK-coated core 12 is placed in a mold and the elastomer material 20 is molded about the core 12, covering both the PEEK-coated and exposed metal regions of the core 12 such that the core 12 is completely encapsulated with the elastomer material 20, except around the fluid opening 16 as noted below. As shown in FIGS. 5 and 6, the elastomer layer 20 covers all but an annular rim region 26 of the bolt hole opening 16. The rim region 26 is thus coated with the high diaelectric PEEK layer material 18, but uncoated with the elastomer material 20. The gasket 10 also has tool stand off regions 24 which are susceptible to abrasion since the project out of the plane of the gasket. These regions 24 may also be shielded from applications of the elastomer layer 20, but are nonetheless coated with the high dielectric PEEK layer 18. The annular rim region 22 of the fluid opening 14 is free of the PEEK material and covered by the elastomer material 20, as shown best in FIG. 7.

In use, the gasket 10 is placed between the mounting flange of an oil cooler core (not shown) and an associated flange or mounting region of the engine block (not shown) and mounting bolts (not shown) are guided through aligned openings in the flanges and through the bolt hole opening 16 of the gasket 10. The PEEK layer 18 has an abrasion and adhesion strength greater than that of the elastomer material 20 and thus resists removal from abrasion due to the bolts being inserted through the bolt hole openings 16 and exposing the bare metal core 12. The high dielectric properties of the PEEK material 18, particularly in the vicinity of the bolt hole openings 16, have the effect of isolating the gasket 10 from any conductive pathway of an electrogalvanic corrosion cell which might otherwise exist in the presence of electrolytic fluid passing through the opening 16 and encountering exposed metal core regions 12 of the gasket 10. The high dielectric PEEK material has shown to interrupt this troublesome corrosion cell and thereby prevent corrosion of the gasket 10 and the mating components that might otherwise result if the PEEK material 18 where not present, particularly in the areas of the bolt hole openings 16 and the standoff regions 24 where there is also no elastomer present, but the standoff regions 24 are nonetheless coated with the PEEK material 18.

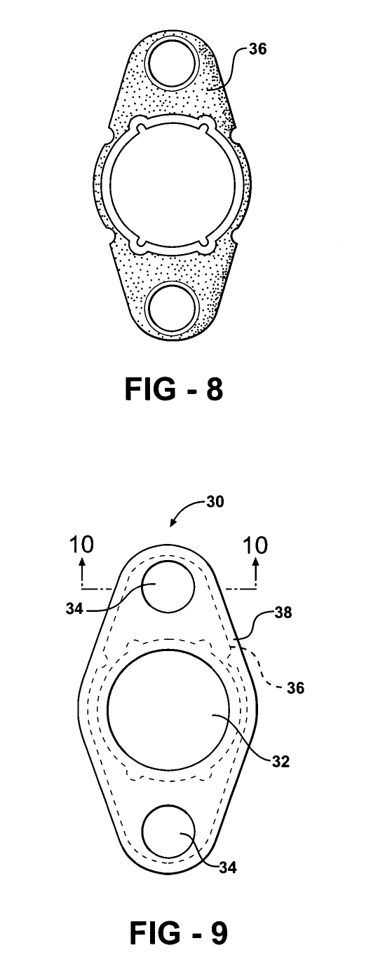

FIGS. 8-10 illustrate an alternative embodiment of the invention in which the gasket 30 if formed with at least one fluid opening 32 and at least one and preferably at least two bolt hole openings 34 that may have the same general configuration of that of the gasket 10. In this embodiment, the gasket 10 includes a core 36 fabricated entirely of PEEK material. The core 36 is over-molded with a layer of elastomer 38, except for a rim region 40 around the bolt hole openings 34 which are entirely PEEK material and uncoated with the elastomer 38. The gasket shares the same advantages as that of the first embodiment.

Obviously, many modifications and variations of the present invention are possible in light of the above teachings. It is, therefore, to be understood that within the scope of the appended claims, the invention may be practiced otherwise than as specifically described.

What is claimed is:

1. A gasket assembly comprising:
at last one metal gasket layer having an opening therethrough for conveyance of fluid media,
a coating of PEEK material applied to at least a portion of the at least one gasket layer; and
a layer of elastomeric sealing material different than that of said PEEK material applied to at least a portion of said at least one gasket layer.

2. The assembly of claim 1, wherein said elastomeric sealing material is applied to at least a portion of said PEEK material.

3. The assembly of claim 2, wherein at least a region of said PEEK material is exposed.

4. The assembly of claim 1 wherein aid elastomeric sealing material is applied to at least a portion of said PEEK material and to at least a portion of said at least one gasket layer.

5. The assembly of claim 1 wherein said PEEK material is spaced from a rear region of said opening, such that said rim region is free of said PEEK material.

6. The assembly of claim 5 wherein said elastomeric material is applied to said rim region.

7. The assembly of claim 5 wherein said at least one gasket layer includes at east one bolt hole that is coated with said PEEK material and free of said elastomer material.

8. A gasket assembly, comprising:
a gasket body fabricated of PEEK material having at least one fluid opening and at least one bolt hole opening; and
a layer of elastomer sealing material applied to said PEEK material.

9. The gasket of FIG. 8 wherein said bolt holes are free of said elastomer material.
